(19) United States
(12) Patent Application Publication
(10) Pub. No.: US 2012/0331290 A1
(43) Pub. Date: Dec. 27, 2012

(54) Method and Apparatus for Establishing Trusted Communication With External Real-Time Clock

(75) Inventors: Evgeny Margolis, Cupertino, CA (US); Paul Lee Chou, Santa Clara, CA (US); Lawrence Madar, III, San Francisco, CA (US); Mark Fullerton, Austin, TX (US)

(73) Assignee: Broadcom Corporation, Irvine, CA (US)

(21) Appl. No.: 13/168,486

(22) Filed: Jun. 24, 2011

(51) Int. Cl. H04L 9/32

(52) U.S. Cl. 713/168

(57) ABSTRACT

Embodiments of the present invention provide systems and methods to enable secure communication between a host processor and external real time counter (RTC) logic. In an embodiment, the host processor generates a message including a command to an external device containing the RTC. The external device verifies a Message Authentication Code (MAC) included in the message and responds to the command. Embodiments of the present invention advantageously provide a dedicated power domain for the external RTC logic while guarding against third party attacks on the RTC logic and the communication between the RTC logic and the host processor.

### FIELD OF THE INVENTION

This invention relates to data communications and more specifically to information security.

### BACKGROUND OF THE INVENTION

A Real-time Clock or Real-time Counter (RTC) is a clock (typically in an integrated circuit) used to monitor time for a computer. Security of RTC modules in a device and RTC values that are transmitted from a device should be ensured so that the RTC information is not compromised by third parties, such as computer hackers.

Previous RTC systems do not support trusted communication between a host processor and RTC logic when the RTC logic is implemented externally from the host processor. Thus, in previous RTC systems, when the RTC is located externally to the host processor, the RTC values are susceptible to hacker attacks and cannot be trusted.

What is needed are systems, apparatuses, methods, and computer program products for providing trusted, secure communication between a host processor and external RTC logic.

### BRIEF DESCRIPTION OF THE DRAWINGS/FIGURES

The accompanying drawings, which are incorporated in and constitute part of the specification, illustrate embodiments of the invention and, together with the general description given above and the detailed descriptions of embodiments given below, serve to explain the principles of the present invention. In the drawings:

FIG. 1 is a block diagram of a system according to an embodiment of the present invention.

FIG. 2 is a block diagram showing the structure of a message according to an embodiment of the present invention.

FIG. 3A is a flowchart illustrating operations undertaken by the host processor according to an embodiment of the present invention.

FIG. 3B is a flowchart illustrating operations undertaken by the External Device (ED) according to an embodiment of the present invention.

FIG. 4A is a flowchart showing communication between a host processor and an ED in an example illustrating an embodiment of the present invention.

FIG. 4B is a block diagram showing the structure of messages sent between a host processor and an ED in an example illustrating an embodiment of the present invention.

Features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

RTC's are a key component for many applications like Digital Rights Management (DRM), Point of Sale (POS) terminals, utility metering, security alarms, security-related equipment, and other security systems. All of these applications require a trusted RTC value that cannot be altered by a hacker. Thus, to ensure that the RTC value is secure, an ideal RTC system implements at least: (1) physical anti-tamper protection of the RTC logic; and (2) trusted communication between a host processor and the RTC.

Trusted communication between the host processor and the RTC is usually ensured when the host processor and RTC storage logic are physically implemented on the same device (e.g., on the same chip). However, locating the RTC storage logic on-chip has certain disadvantages.

For example, in on-chip embodiments, the RTC module is often required to be supplied by a different power source than the power source used by the host processor so the RTC continues to have access to power even when the host processor is powered down. In some on-chip embodiments, the RTC module is individually supplied with power using a small battery, such as a coin cell battery.

Customers may have strong requirements for RTC power efficiency so that the RTC module can continue to operate from battery power for a long period of time. For example, some customers require that the RTC be efficient enough to operate from battery power for at least one year. Such customer demands can be difficult to meet as chip capabilities and complexity (and thus power requirements) increase. These customer demands are further complicated by a high power leakage from the silicon host processor chip, which further reduces power efficiency. For example, as transistors in chips become smaller, more power is lost via leakage due to a decreasing distance between transistor elements.

While disabling some RTC features can increase the power efficiency of an RTC module of a device, disabling RTC features leads to a decrease in RTC functionality. Embodiments of the present invention advantageously provide new solutions to meet strict customer power requirements while preserving the full functionality of the RTC module.

One solution to meeting customer power requirements proposed by embodiments of the present invention is locating the RTC off-chip from the host processor. For example, an embodiment of the present invention locates the RTC on an External Device (ED) that is designed to support stringent customer power requirements. For example, in an embodiment, the ED chip contains transistors that are less susceptible to power leakage (e.g., larger transistors) to maximize the power efficiency of the ED. In an embodiment, the ED is a Power Management Unit (PMU).

When RTC logic is implemented externally, extra precautions should be taken to guarantee trusted communication between the host processor and the off-chip RTC logic so that hackers cannot alter data as the RTC and the host processor communicate. Embodiments of the present invention provide systems, apparatuses, methods, algorithms, and computer program products to enable secure communication between the host processor and external RTC logic.

Embodiments of the present invention further provide a dedicated power domain for the external RTC logic with a dedicated power input from the ED. Additionally, some embodiments of the present invention advantageously alleviate potential leakage issues in the ED by incorporating special thick oxide libraries and/or voltage level shifter cells into the ED.

### 2. Systems

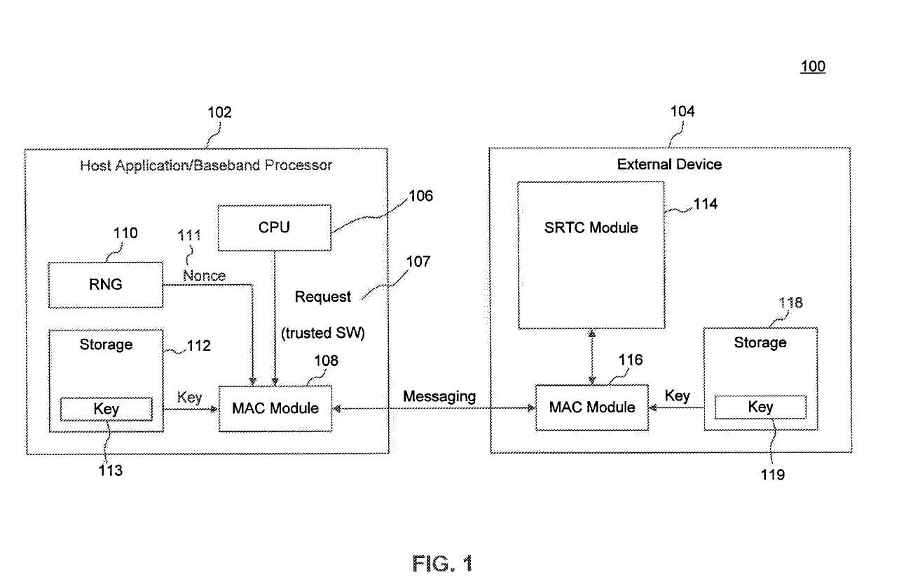

FIG. 1 is a block diagram of a system 100 according to an embodiment of the present invention. In FIG. 1, Secure Real Time Clock (SRTC) module 114 is located on a separate chip (“External Device” or “ED”) 104 from host processor 102. Host processor 102 contains a central processing unit (CPU) 106, a Message Authentication Code (MAC) module 108 for generating a Message Authentication Code (MAC), a random number generator (RNG) module 110, and a storage module 112 storing a secret Message Authentication Key (“MAK” or “secret key”) 113.

In an embodiment, MAC module 108 is a Hash-based Message Authentication Code (HMAC) function module. However, it should be understood that MAC module 108 can use a variety of different functions to generate a MAC. For example, MAC module 108 can use any of the HMACs (e.g., HMAC-MD5, HMAC-SH1, HMAC-SHA256, HMAC-SHA384, and/or HMAC-SHA512). Further, AES, DES, or TDES can be used in the Cipher Block Chaining (CBC) mode, among other possible modes, to generate a MAC in accordance with an embodiment of the present invention.

In an embodiment storage module 112 is non-volatile memory. For example, storage module 112 can be a one-time programmable (OTP) memory storing a programmed secret key 113. In another embodiment, secret key 113 is a permanent key (e.g., hardwired in silicon). In a further embodiment, secret key 113 is stored in secure flops.

In an embodiment, SRTC module 114 contains a battery backup logic (BBL) module that provides a dedicated (e.g., always on) power supply for the SRTC with a dedicated power input from ED 104. In an embodiment, this dedicated power supply is backed up by a coin cell battery. In an embodiment, ED 104 incorporates special thick oxide libraries and/or voltage level shifter cells to alleviate the potential for power leakage. However, it should be understood that these features are optional.

In an embodiment, SRTC module 114 contains a monotonic counter (MC) configured to count in one direction (i.e., up or down) in addition to the real-time counter (RTC). However, it should be understood that SRTC module 114 can contain any mechanism or counting logic that does not repeat the same value twice. SRTC module 114 may also include a status register for registering any security violation events. In an embodiment, this status register is checked when the RTC is read by the system to ensure that no violations have occurred and that the RTC value being read has not been compromised (e.g., by a hacker or other third party). Different monitors and/or detectors may also be included in SRTC module 114, including voltage monitor(s), frequency monitor(s), temperature monitor(s), wiremesh tamper monitor(s), cosmic radiation monitor(s), static electricity monitor(s), and/or logic fault detector(s). ED 104 also includes a MAC module 116 for generating a message authentication code (MAC) and an storage module 118 storing a key used to authenticate the message that includes MC, RTC, and control/status data. As discussed above, MAC module 116 can use any of the HMACs (e.g., HMAC-MD5, HMAC-SH1, HMAC-SHA256, HMAC-SHA384, and/or HMAC-SHA512). Further, AES, DES, or TDES can be used in the Cipher Block Chaining (CBC) mode, among other possible modes, to generate a MAC in accordance with an embodiment of the present invention.

Elements within host processor 102 and ED 104 can be implemented with one or more processors. For example, in an embodiment, MAC module 108 uses CPU 106 to process information. In another embodiment, MAC module 108 is implemented on (or using) a separate processor from CPU 106, or dedicated circuit logic. Additionally, in an embodiment, MAC module 116 is implemented on a separate processor from the rest of the elements on ED 104, or dedicated circuit logic. In another embodiment, MAC module 116 shares a processor with other elements of ED 104. Further, it should be understood that host processor 102 and ED 104, and elements therein, may be implemented using hardware or software.

MAC modules 108 and 116 may be implemented using hardware or trusted software. Further, while host processor 102 and ED 104 are shown incorporating MAC modules 108 and 116, it should be understood that a variety of cryptographic techniques are envisioned by embodiments of the present invention, and host processor 102 and/or ED 104 may include a variety of cryptographic modules configured to generate a MAC for messages using any cryptographic technique.

Host processor 102 and ED 104 are configured to communicate with each other. In an embodiment, host processor 102 and ED 104 communicate using messages. These messages may be sent wirelessly or over a wired connection. Embodiments of the present invention envision a variety of wired or wireless messaging techniques including, but not limited to: a hardwired connection (e.g., via Inter-Integrated Circuit [I2C] or Universal Asynchronous Receiver/Transmitter [UART]), Wi-Fi communication, Bluetooth, IEEE 1394 communication, IEEE 802.3 communication, USB communication, and/or SMS messaging.

In an embodiment, the keys stored in storage module 112 and storage module 118 are identical (i.e., the same key is used for message authentication in host processor 102 and ED 104). For example, in an embodiment, Message Authentication Keys (MAKs) 113 and 119 are generated during manufacturing of the chips for host processor 102 and ED 104 and are stored, respectively, in storage modules 112 and 118 so that each pair of manufactured host processor 102 and ED 104 chips contain corresponding, identical keys. In an embodiment, any attempts to reprogram these keys are disabled once the keys are initially programmed. In a further embodiment, one key is used to generate and authenticate the MAC for messages sent from host processor 102 to ED 104, and another key is used to generate and authenticate the MAC for messages sent from ED 104 to host processor 102.

In an embodiment, all host processor 102 chips and ED 104 chips contain identical keys generated during manufacturing so that any host processor 102 can securely communicate with any ED 104 and so that any ED 104 can securely communicate with any host processor 102. Having identical keys in all devices advantageously eases the manufacturing process and enables all CPUs 106 to work with all EDs 104. However, this approach may compromise security because an ED 104 can be used to generate an incorrect response message to a host processor 102.

In an embodiment, CPU 106 sends a request 107 to read the value of the RTC stored on ED 104. This request is appended with a MAC using MAC module 108 and the MAK 113 stored in storage module 112, and both the MAC and a message containing the request are sent to ED 104. MAC module 116 generates a MAC for the received message using the MAK 119 stored in storage module 118. If the MAC sent by MAC module 108 with the message matches the MAC generated from the received message by MAC module 116, ED 104 can verify that the request came from host processor 102. In an embodiment, ED 104 is configured to respond only to verified requests. In another embodiment, ED 104 is configured to respond to any request regardless of whether the request contains a valid MAC.

When ED 104 receives a valid request for an RTC, ED 104 generates a MAC for the RTC value with MAC module 116 using the MAK 119 stored in storage module 118. A message containing the MAC, the RTC value, and a value from the status register is sent to host processor 102. MAC module 108 generates a MAC for the received message using the MAK 113 stored in storage module 112. If the MAC sent by MAC module 116 with the message matches the MAC generated from the received message by MAC module 108, host processor 102 can verify that the RTC value is accurate and was not compromised by a third party during transit from ED 104. Host processor 102 can further verify that the RTC value was not corrupted by a third party prior to transmission of the message by checking the status value sent in the message.

In an embodiment, a nonce (number used once) may be used to further validate responses to commands from host processor 102 by providing protection against replay attacks, in which a third party records a message in transit and later retransmits the same message in an attempt to imitate the sender and initiate an additional response from the recipient. For example, in an embodiment, RNG module 110 generates a nonce 111 in the message sent to ED 104. After RNG module 110 generates nonce 111, nonce 111 is stored by host processor 102. In an embodiment, nonce 111 is stored in a register, and the value of this register is overwritten each time RNG module 110 generates a new nonce 111. Nonce 111 is verified as originating from host processor 102 when ED 104 checks the MAC of the message sent by MAC module 108 with the message against the MAC generated by MAC module 116 from the received message.

In an embodiment, the ED includes the nonce in the response sent back to host processor 102. After host processor 102 receives the response from ED 104, host processor 102 can guard against replay attacks by comparing the nonce sent by ED 104 against the nonce that was last generated by RNG module 110 and stored by host processor 102 (e.g., in the register discussed above). In an embodiment, the nonce length is 128 bits. However, the nonce length may be changeable. In an embodiment, a nonce length parameter is also included in the message.

System 100 can be configured to generate and respond to a variety of other commands in addition to requests for RTC values. For example, commands that may be sent by host processor 102 to ED 104 include: (1) RTC program (for initializing the RTC upon the first boot up); (2) MC Increment (to increment the value of the monotonic counter); (3) Status Clear (to clear the value of the status register in SRTC module 114); and (4) SRTC Read (to read any combination of the RTC value, MC value, and/or status register). In an embodiment, a SRTC Read command may also be used to read the value of the monitors in SRTC module 114 (including, for example, voltage monitor(s), frequency monitor(s), and/or temperature monitor(s)).

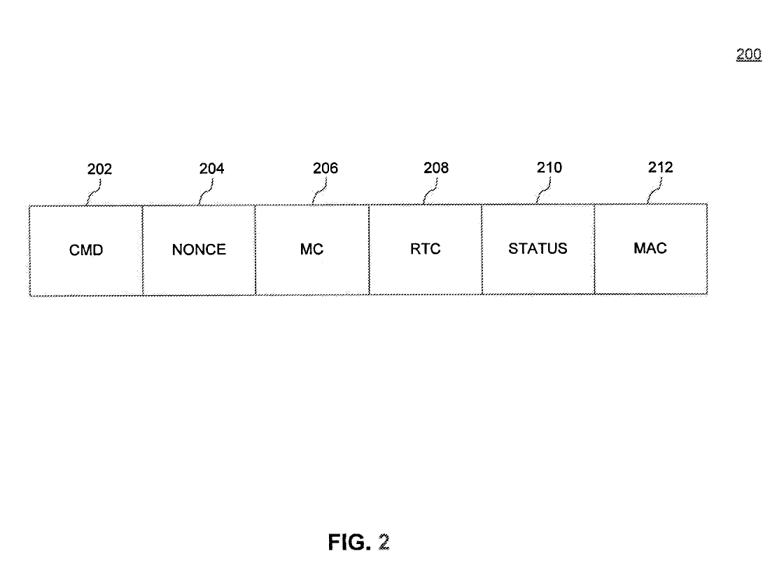

FIG. 2 is a block diagram showing the structure of a message 200 according to an embodiment of the present invention. In FIG. 2, message 200 includes a command portion 202 identifying a command from host processor 102 to ED 104, a nonce portion 204 containing nonce 111 generated by RNG module 110, a MC portion 206 containing the value of the monotonic counter of SRTC module 114, a RTC portion 208 containing a value to be programmed into the RTC or the current value of the RTC from SRTC module 114, a status portion 210 containing the value of the status register of SRTC module 114, and a message authentication code (MAC) portion 212 containing the MAC generated by MAC module 108.

Command portion 102 of message 200 may be, for example, a command code ma text command. In an embodiment, ED 104 executes a routine associated with the command after verifying the message. For example, in an embodiment, after ED 104 receives a “Status Clear” command, ED accesses code associated with “Status Clear” and executes the code to clear the status register in SRTC module 114.

Nonce portion 204 of message 200 is used to store the nonce 111 generated by RNG module 110. As previously discussed, nonce portion 204 is used to guard against replay attacks that impersonate a response from ED 104 to host processor 102. Further, as discussed above, nonce portion 204 is optional, and messages according to embodiments of the present invention may be sent and received without using nonce portion 204.

MC portion 206 of message 200 is used to store the monotonic counter value from SRTC module 114. MC portion 206 can be used to guard against replay attacks that impersonate a command from host processor 102 to ED 104. For example, a replay attack may be used to attempt to reprogram ED 104 by recording and “replaying” a previous reprogram command sent by host processor 102. In an embodiment, MC portion 206 of message 200 is only present for reprogram commands (e.g., a command attempting to write information to the ED). These reprogram commands include: (1) RTC Program Request; (2) MC Increment Request; (3) Status Clear; and (4) MC Read Response. Each time ED 104 receives a reprogram command, ED 104 compares the value of the monotonic counter in SRTC module 114 with the value of MC portion 206 of the received message containing the reprogram command. If the values match, ED 104 executes the code associated with the reprogram command and increments the monotonic counter. If the values do not match, ED 104 determines that the received message containing the reprogram command was an attempted replay attack and takes no action. Thus, any reprogram command containing a certain value for a MC will only be valid once, and subsequent reprogram commands containing the same MC value will be ignored. In an embodiment, the monotonic counter value can be used by host processor 102 as a general purpose MC for any cryptographic application not related to the RTC messaging described herein.

As previously discussed, host processor 102 can determine the current value of the MC by sending a “SRTC Read” command to read the current value of the MC. This MC value may be stored in host processor 102 (e.g., in a register) for use in a later reprogram command. As previously discussed, reprogram commands using any particular MC value are only valid once, so, in an embodiment, the current value of the MC of SRTC module 114 is read prior to sending subsequent reprogram commands.

In another embodiment, the MC value is sent to host processor 102 each time the MC of SRTC module 114 is changed (e.g., incremented). Thus, according to this embodiment, host processor 102 always stores the current value of the MC and does not need to read the MC before sending each reprogram command.

In yet another embodiment, host processor 102 also includes a monotonic counter, and ED 104 is configured to send a message to host processor 102 after reprogramming ED 104 in response to a valid reprogram command. After host processor 102 receives the message indicating the reprogram command was successfully executed, host processor updates its monotonic counter. Thus, in this embodiment, host processor 102 may send commands without having to read the current value of the monotonic counter in SRTC module 114 prior to sending each new command.

Further, MC portion 206 of message 200 is optional, and messages according to embodiments of the present invention may be sent and received without using MC portion 206. Additionally, while the monotonic counter of SRTC module 114 is discussed above as being a counter that is incremented, embodiments of the invention are envisioned using a MC that is incremented or decremented by any value (or that is randomly generated), as long as the MC value does not repeat. In an embodiment, the MC is 32 bits long; however, longer MC's are envisioned by embodiments of the present invention (for example, a 64 bit MC).

RTC portion 208 of message 200 is used to store the RTC value from SRTC module 114. If message 200 contains a command to reprogram the RTC, RTC portion 208 contains the value of the RTC to be programmed into ED 104. Ideally, the RTC is programmed only once (e.g., during manufacturing or upon the first power-up). However, embodiments of the present invention are envisioned that allow for the RTC to be reprogrammed any number of times. In an embodiment, an initial value for the RTC can be read once after host processor 102 powers up. This value can be stored in an internal counter register, and the RTC will track real time relative to this initial value thereafter.

If a command to read the value of the RTC is sent, the response from ED 104 will contain a RTC portion 208 with the current value of the RTC in SRTC module 114. In an embodiment, the RTC is 32 bits long, however longer RTC's are envisioned by embodiments of the present invention (for example, a 64 bit RTC).

Status portion 210 of message 200 is used to store the status value from the status register of SRTC module 114. As discussed above, the status register of SRTC module 114 is configured to capture security violations resulting from an attack on ED 104 by a third party (such as a hacker). For example, in an embodiment, if the battery powering SRTC module 114 is removed, the value of status register of SRTC module 114 is cleared, and status portion 210 will contain this “cleared” value of the status register. After host processor 102 receives a message indicating that the status register has been cleared, host processor 102 can initiate command(s) to reprogram ED 104.

In another embodiment, status portion 210 contains a message and/or code identifying a type of attack. Alternatively, status portion 210 may contain a binary flag that is set to “1” or “0” in the event that an attempted attack on ED 104 is detected. If host processor 102 receives a message with the status flag indicating that an attack took place, host processor 102 may send a “Status Read” command to ED 104 to obtain the value of the status register of SRTC module 114, which stores more information regarding the attack or attempted attack.

MAC portion 212 of message 200 is used to store the message authentication code (MAC) generated by MAC module 108 or 116 using the MAK 113 or 119 generated by storage module 112 or 118. A variety of cryptographic algorithms are envisioned to generate the MAC, including: MD5, SHA-1, SHA-256, DES, etc. In an embodiment, the length of MAC portion 212 is 256 bits. However, embodiments of the present invention are envisioned with MACs of a variety of lengths.

### 3. Methods

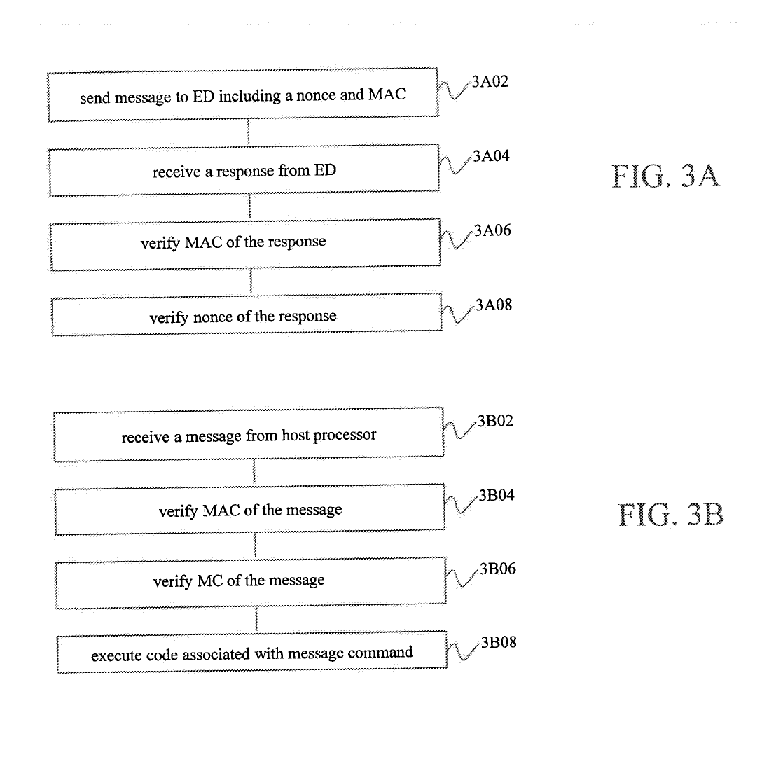

Operations undertaken by host processor 102 according to an embodiment of the present invention will now be explained with reference to FIGS. 3A and 1. In step 3A02, host processor 102 sends a message to ED 104. To create the message, host processor 102 generates nonce 111 using RNG module 110 and appends the nonce to a command to be sent to ED 104. Host processor 102 generates a MAC for the message with MAC module 108 using MAK 113 from storage module 112.

In step 3A04, host processor 102 receives a response from ED 104 stating that the command was properly executed. In step 3A06, host processor 102 verifies the MAC of the response. To verify the MAC, host processor generates a MAC for the response and verifies that the generated MAC matches the received MAC. In step 3A08, host processor 102 verifies the nonce field of the response. This step is optional. To verify the nonce, host processor verifies that the nonce field of the response matches the nonce 111 last generated by RNG module 110. If host processor 102 determines that the nonce and the MAC of the response are valid, host processor 102 can trust that the response is valid and that the command was properly executed.

Operations undertaken by ED 104 according to an embodiment of the present invention will now be explained with reference to FIGS. 3B and 1. In step 3B02, ED 104 receives a message from host processor 102 including a command to the ED 104. In step 3B04, ED 104 verifies the MAC of the message. To verify the MAC, ED generates a MAC for the message with MAC module 116 using MAK 119 from storage module 118 and verifies that the MAC value matches the received MAC of the message. In step 3B06, ED 104 verifies the MC of the message. This step is optional. For example, the MC of the message may be verified if ED 104 determines that the message contains a reprogram command. To verify the MC, ED 104 verifies that the MC field of the message matches the current value of the MC in SRTC module 114.

In step 3B08, ED 104 executes code associated with the message command. For example, if the message command is a command to read the value of the RTC, ED 104 generates a response to host processor 102 including the RTC. In an embodiment, ED 104 includes a command field in the response indicating that the response contains the value of the RTC. In an embodiment, ED further includes the value of a nonce received from host processor 102, the value of the status register of SRTC module 114, and/or the current value of the MC in the response. ED 104 generates a MAC for the response and transmits it to the host processor.

### 4. Example

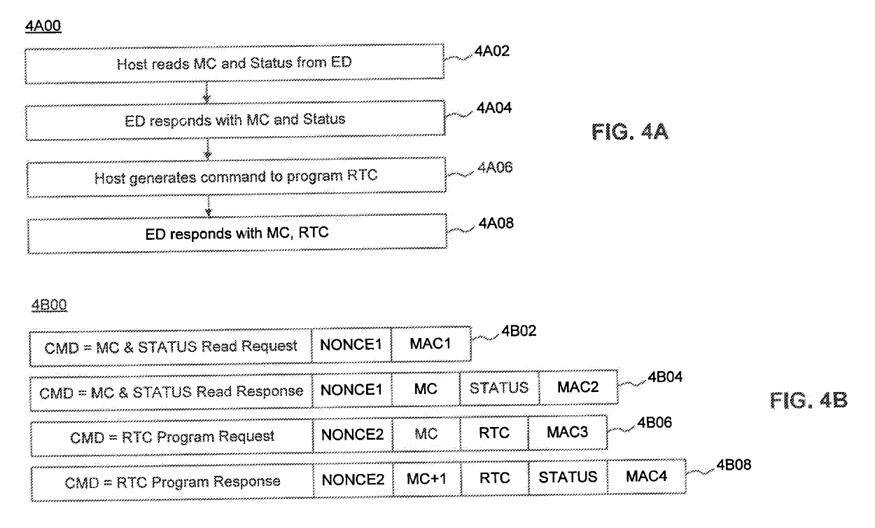

An example illustrating a series of messages sent between host processor 102 and ED 104 will now be explained with reference to FIGS. 4A, 4B, and 1. In step 4A02, host processor 102 determines that a command should be sent to ED 104 to read the MC value and status register of SRTC module 114 of ED 104. Before sending a message containing the command, host processor 102 generates a nonce 111 using RNG module 110, appends it to the command, and generates a MAC for a message containing the command and nonce 111 with MAC module 108 using the MAK 113 stored in storage module 112. MAC module 108 generates a MAC value, which is appended to the message.

Element 4B02 of FIG. 4B shows the format of this message. As shown in element 4B02, message 4B02 contains the command to read the MC value and status register. Message 4B02 also contains nonce 111 (“NONCE1”) generated by RNG module 110 to guard against replay attacks mimicking a response from ED 104. Additionally, message 4B02 is appended with the MAC value (“MAC1”) so that ED 104 can verify that message 4B02 originated from host processor 102.

After ED 104 receives message 4B02, it verifies that message 4B02 originated from host processor 102 by generating a MAC for message 4B02 using MAC module 116 and MAK 119 from storage module 118. If the MAC generated by MAC module 116 matches the MAC (“MAC1”) of message 4B02, ED 104 determines that message 4B02 originated from host processor 102.

ED 104 then reads the command(s) in message 4B02. Since the command(s) are commands to read values from ED 104 and not command(s) to reprogram ED 104, it is not necessary for ED 104 to ensure that a MC portion of message 4B02 matches the value of the MC in SRTC module 114. ED 104 then proceeds to execute code associated with the command(s) and prepares to send a response to host processor 102 containing the value of the MC and status register of SRTC module 114.

ED 104 reads the value of the MC and status register of SRTC module 114 and places these values in a response message. ED 104 also includes nonce 111 (received from host processor 102) in the message. Element 4B04 of FIG. 4B shows the format of this message. The command field of message 4B04 indicates that message 4B04 contains a response from ED 104 containing the values of the MC and status register of SRTC module 114. ED 104 generates a MAC for message 4B04 (“MAC2”) with MAC module 116 using MAK 119 generated by storage module 118. In step 4A04 of FIG. 4A, ED 104 responds to host processor 102 with message 4B04.

After host processor 102 receives message 4804, host processor checks the MAC of message 4B04 by generating a MAC for message 4B04 and checking the generated MAC against the received MAC in message 4B04. Host processor 102 also checks the nonce field of message 4B04 against the last nonce generated by RNG module 110 to guard against replay attacks. It should be noted that host processor 102 may be configured to check the nonce field of a received message before, after, or simultaneously with checking the MAC of a received message.

After host processor 102 has checked the MAC and nonce field of message 4B04, host processor 102 determines that message 4B04 originated from ED 104 and that message 4B04 is not an attempted replay attack. Host processor then reads the command field of message 4B04 and determines that message 4B04 is a response from ED 104 containing the value of the MC and status register of SRTC module 114. Host processor 102 may optionally store the MC value and/or the value of the status register for later use.

In step 4A06, host processor 102 generates a command to program the RTC of ED 104. This can happen, for example, if host processor 102 determines that the status register of SRTC module 114 has been cleared and that the RTC of SRTC module 114 should be reinitialized. As previously discussed, the status register of SRTC module 114 may become cleared if, for example, the battery powering SRTC module 114 is removed.

Host processor 102 generates a new nonce 111 (“NONCE2”) and puts it in a new message 4B06 to send to ED 104. Message 4B06 contains a command field indicating that host processor is attempting to reprogram the RTC of ED 104, the new nonce 111, the new incremented MC value that was just sent from ED 104, and the new RTC value to be programmed into ED 104. Host processor 102 then generates a MAC for 4B06, appends the MAC (“MAC3”), and sends message 4B06 to ED 104.

After ED 104 receives message 4B06, ED 104 generates a MAC for message 4B06 and determines if the MAC generated by ED 104 matches the MAC of message 4B06. ED 104 reads the command field of message 4B06 and determines that message 4B06 contains a command to reprogram the RTC of SRTC module 114. Since message 4B06 contains a reprogram request, ED 104 verifies that the MC field of message 4B06 matches the current value of the MC in SRTC module 114 to guard against attempted replay attacks. If the values do not match, ED 104 determines that message 4B06 is an attempted replay attack and takes no action. If the values do match, ED 104 determines that a valid reprogram command has been received and executes code associated with the command received from message 4B06. For example, ED replaces the value of the RTC in SRTC module 114 with the value received in the RTC field of message 4B06. After reprogramming the RTC, ED 104 updates (i.e., increments) the MC in SRTC module 114 to guard against replay attacks.

In step 4A08, ED 104 sends a response to host processor 102 indicating that the RTC program command was successful. Element 4B08 shows one possible format of such a response message according to an embodiment of the present invention. Message 4B08 includes a command field indicating that message 4B08 is a response from ED 104 indicating that that the RTC was successfully reprogrammed. Message 4B08 also includes the nonce value received by ED 104 with reprogram message 4B06. Message 4B08 can also include the new values of the MC, RTC, and/or status register of SRTC module 114. ED 104 generates a MAC for message 4B08 (“MAC4”) and sends message 4B08 to host processor 102.

After host processor 102 receives message 4B08, host processor 102 verities the MAC and nonce value of message 4B08 to verify that message 4B08 originated from ED 104 and that message 4B08 is not an attempted replay attack. Host processor 102 then reads the command field of message 4B08 and determines that message 4B08 contains a response from ED 104 indicating that an attempt to reprogram the RTC of ED 104 was successful. In an embodiment, host processor 102 can then stores the new values of the MC, RTC, and/or status fields sent in message 4B08 for later use.

### 5. Conclusion

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g. software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present invention.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system comprising:
a host processor module including a first cryptographic module, wherein the host processor is configured to:
generate a command,
generate a first Message Authentication Code (MAC) using the first cryptographic module, and
generate a message including the first MAC and the command; and
an external device (ED) in communication with the host processor,
wherein the ED includes a real time counter (RTC) and a dedicated power domain configured to provide power to the RTC, and
wherein the ED is configured to:
receive the message,
verify the first MAC, and
respond to the message using the RTC.

2. The system of claim 1, wherein the ED further includes a second cryptographic module, and wherein the ED is further configured to:
generate a second MAC using the second cryptographic module; and
compare the second MAC to the first MAC to verify the first MAC.

3. The system of claim 2, wherein the first cryptographic module and the second cryptographic module are Message Authentication Code (MAC) modules.

4. The system of claim 2, wherein the host processor further includes a first storage module storing a first cryptographic key, and wherein the ED further includes a second storage module storing a second cryptographic key identical to the first cryptographic key.

5. The system of claim 4, wherein the first cryptographic module is configured to generate the first MAC using the first cryptographic key, and wherein the second cryptographic module is configured to generate the second MAC using the second cryptographic key.

6. The system of claim 1, wherein the host processor module further includes a random number generator (RNG) module configured to generate a nonce, wherein the message includes the nonce, wherein the ED is further configured to generate a response including the nonce, and wherein the host processor is further configured to verify the nonce in the response.

7. The system of claim 1, wherein the ED further includes a monotonic counter (MC) storing a MC value, wherein the message includes a MC field, and wherein the ED is further configured to compare the MC field to the MC value prior to responding to the message.

8. The system of claim 7, wherein the ED is configured to increment the MC after responding to the message.

9. The system of claim 1, wherein the ED further includes a status register configured to store status information regarding attempted attacks on the ED by a third party, and wherein the ED is configured to communicate the status information to the host processor.

10. The system of claim 1, wherein the ED further includes a plurality of monitors, and wherein the plurality of monitors include:
a voltage monitor;
a frequency monitor; or
a temperature monitor.

11. An device in communication with a remote host processor, wherein the device includes a dedicated power domain configured to provide power to a real time counter (RTC), and wherein the device is configured to:
receive a message from the host processor including a first Message Authentication Code (MAC);
generate a second MAC for the message using a cryptographic module;
verify that the first MAC matches the second MAC;
access a RTC value from the RTC; and
generate a response to the host processor using the RTC value.

12. The system of claim 11, wherein the device further includes a storage module storing a cryptographic key, and wherein the device is configured to generate the MAC using the cryptographic key.

13. The system of claim 11, wherein the message includes a nonce, wherein the device is further configured to include the nonce in the response.

14. The system of claim 11, wherein the device further includes a monotonic counter (MC) storing a MC value, wherein the message includes a MC field, and wherein the device is further configured to compare the MC field to the MC value prior to generating the response.

15. The system of claim 14, wherein the device is configured to increment the MC after generating the response.

16. The system of claim 11, wherein the device further includes a status register configured to store status information regarding attempted attacks on the device by a third party, and wherein the device is configured to communicate the status information to the host processor.

17. The system of claim 11, wherein the device further includes a plurality of monitors, and wherein the plurality of monitors include:
a voltage monitor;
a frequency monitor;
a temperature monitor;
a wiremesh tamper monitor;
a cosmic radiation monitor;
a static electricity monitor; or
a logic fault detector.

18. A method comprising:
receiving a message from a remote host processor, wherein the message includes a command and a Message Authentication Code (MAC);
verifying the MAC;
accessing a real time counter (RTC);
executing code associated with the command; and
transmitting a response to the host processor.

19. The method of claim 18, further comprising:
accessing a value of a monotonic counter (MC);
verifying that a MC field of the message matches the value of the MC;
incrementing the MC after executing the code; and
transmitting the incremented MC value in the response.

20. The method of claim 18, wherein verifying the MAC further comprises:
accessing a one-time programmable (OTP) memory storing a cryptographic key;
generating a second MAC for the message using the cryptographic key; and
verifying that the second MAC matches the MAC.
